(19) United States
(12) Patent Application Publication
(10) Pub. No.: US 2021/0011929 A1
(43) Pub. Date: Jan. 14, 2021

(54) METHOD FOR CREATIG RELATIONAL DATABASE TABLE(S) FOR A FORM

(71) Applicant: Anhui University of Technology, Ma'ansha City (CN)

(72) Inventors: Muyun Fang, Ma'anshan City (CN); Huidong Wu, Dongtai City (CN); Zhen Qiu, Nanjing City (CN); Yu Liu, Pinghu Township (CN); Xianxian Zhao, Wudian Town (CN); Haibo Liu, Xinghua City (CN); Qing Huang, Anqing City (CN)

(21) Appl. No.: 16/921,549

(22) Filed: Jul. 6, 2020

(30) Foreign Application Priority Data
Jul. 8, 2019 (CN) 2019106108794

(51) Int. Cl. G06F 16/28; G06F 16/22

(52) U.S. Cl. CPC G06F 16/284; G06F 16/2282

(57) ABSTRACT

The present invention discloses a method for creating relational database table (s) for a form, which relates to the technical field of software development. A form is mapped to two database tables: a Table Main and a Table Detail, wherein the Table Main is used for storing the attributives of the table header and footer; the Table Detail is used for storing the attributives of the table body; the records of the two tables are associated by header numbers, which are primary keys, not combinations of primary keys from external entities, but independently generated serial numbers with business meaning. The application of the present invention solves the problems of redundant storage and slow access.

### TECHNICAL FIELD

The present invention relates to the technical field of software development, and in particular to a method for creating relational database table (s) for a form.

### BACKGROUND TECHNOLOGY

The ER model of the relational database is an abstraction of the real world, and the theoretical basis for the design of relational databases. In ER model theory, in case an entity is mapped to a table, the primary key of the entity is the primary key of the table; in case a 1:1 relationship is mapped to a table by merging any 1-end entity, the primary key of any 1-end entity is the table's primary key; in case a 1: n relationship is mapped to a table by merging 1 end entity, the primary key of the 1 end entity is the primary key of the table; in case an n: m relationship is mapped to a table separately, the primary keys of the two entities jointly become the primary key of the table.

In practice, many-to-many relationships between multiple entities (more than 2) count for the most of all relationships. Forms (the basic unit of information exchange in the management process) belong to n: m relationships between multiple entities, e.g. leave slips, transcripts and warehouse receipts. People generally use forms to exchange information, rather than entities or the connections between two entities. However, at present, the commonly used forms have the problems of storage redundancy and slow access in the storage and access process.

### SUMMARY OF THE INVENTION

To solve the problems of storage redundancy and slow access in the storage and access process thereto, the technical solutions are provided as follows:

The present invention provides a method for creating relational database table (s) for a form, which is applied to the code generation of information management software development, and includes the following steps:

The form is divided into a header, a body and a footer;

With regard to the header, x-1 attributives are first created: H2, H3, . . . Hx, and then H1 as a header number attributive is created;

With regard to the body, y attributives are created: B1, B2, . . . , By;

With regard to the footer, z attributives are created: T1, T2, . . . , Tz;

A Table Main is created, whose fields are: H1, H2, H3, . . . , Hx and T1,T2,. . . ,Tz, where H1 stores the header number; .

A Table Detail is created, whose fields are: H1 and B1, B2, . . . , By, where H1 stores the header number.

Further, the z attributives in the footer are used for storing the information of form handling person, auditors at all levels and status.

The present invention maps a form to two database tables: a Table Main and a Table Detail, wherein the Table Main is used for storing the attributives of the header and the footer of the table; the Table Detail is used for storing the attributives of the body of the table; the records of the two tables are associated by header numbers, which are primary keys, not combinations of primary keys from external entities, but independently generated serial numbers with business meaning. The application of the invention solves the problems of redundant storage and slow access.

### BRIEF DESCRIPTION OF THE FIGURES

The accompanying drawings required in the embodiments will be briefly introduced for clear understanding of the embodiments of the present invention or the technical solutions in the prior art. Obviously, the drawings described below can be understood as various embodiments of the present invention only. For those of ordinary skill in the art, without making creative work, other drawings can also be obtained from these drawings.

FIG. 1 is a schematic diagram of a form divided into a header, a body and a footer in an embodiment of the present invention;

FIG. 2 is a schematic diagram of the fields of the header, body and footer of the form in an embodiment of the present invention;

FIG. 3 is a schematic diagram of the relationship between the form and the tables.

### DETAILED DESCRIPTION OF THE INVENTION

The technical solutions in the embodiments will be now clearly and completely described with reference to the accompanying drawings. It is obvious that the embodiments described herein are merely part of the implementations of the present invention, and should not be considered as all the implementations. Based on the embodiments of the present invention, all other embodiments obtained by those of ordinary skill in the art without making creative efforts should fall within the protection scope of the invention.

The present invention provides a method for creating relational database table (s) for a form, which includes the following steps:

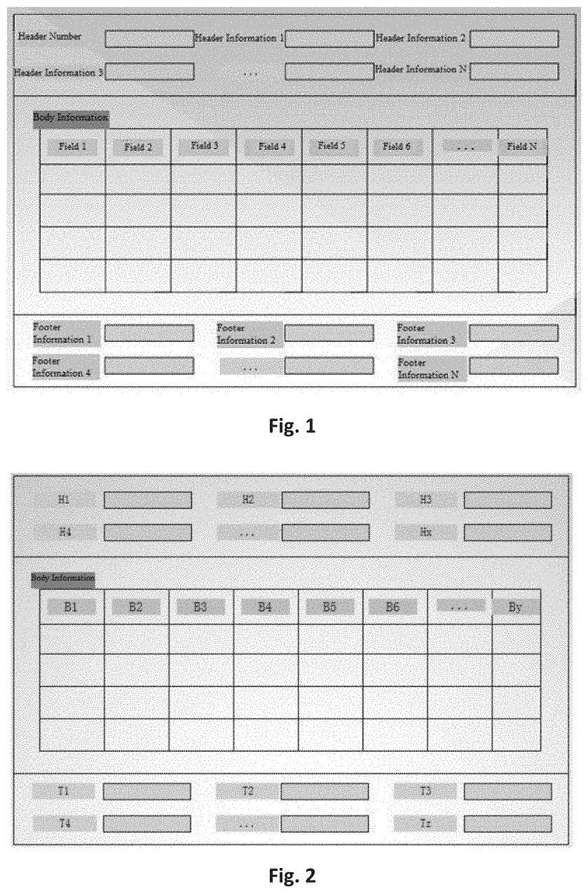

a. The form is divided into a header, a body and a footer. The blank form is as shown in FIG. 1.

b. With regard to the header, x-1 (x>=2) attributives are first created: H2, H3, . . . , Hx, all of which are the relationships between the form and multiple external business entities; and then H1 as a header number attributive is created to identify the form.

c. With regard to the body, y (y>=1) attributives are created: B1, B2, . . . , By. The body is the core content of information exchange and a key part of a form to distinguish from other forms.

d. With regard to the footer, z (z>=1) attributives are created: T1, T2, . . . , Tz. The footer generally expresses form handling person, auditors at all levels and status. The result of the form after the fields are created is as shown in FIG. 2.

e. A Table Main is created, whose fields: H1, H2, H3, . . . , Hx and T1,T2, . . . ,Tz, where H1 stores the header number.

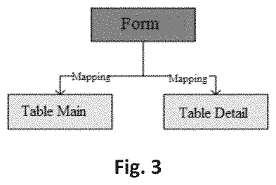

f. A Table Detail is created, whose fields are: H1 and B1, B2, . . . , By, where H1 stores the header number. The mapping process and table results are as shown in FIG. 3 and Table 1, 2:

TABLE 1
Table Main

| | | | | | | |
|---|---|---|---|---|---|---|
| H₁ | H₂ | - - - | Hₓ | T₁ | - - - | T_{z} |

| | | | |
|---|---|---|---|
| - - - | - - - | - - - | - - - |
| - - - | - - - | - - - | - - - |

TABLE 2
Table Detail

| H₁ | B₁ | - - - | B_{y} |
|---|---|---|---|
| - - - | - - - | - - - | - - - |
| - - - | - - - | - - - | - - - |

Despite the foregoing descriptions of the preferred embodiments of the present invention, additional changes and modifications can be made by those skilled in the art to these embodiments upon knowing the basic inventive concepts. Therefore, it should be interpreted that the claims intend to include the preferred embodiments and all changes and modifications falling within the scope of the present invention.

It is obvious that various modifications and variations can be made by those skilled in the art to the present invention without departing from the spirit and scope of the present invention. Thus, if these modifications and variations of the present invention fall within the scope of the claims of the present invention and equivalent technologies thereof, the present invention should include these modifications and variations.

1. A method for creating relational database table (s) for a form, characterized by the following steps:
The form is divided into a header, a body and a footer;
With regard to the header, x-1 attributives are first created: H2, H3, . . . , Hx, and then H1 as a header number attributive is created;
With regard to the body, y attributives are created: B1, B2, . . . , By;
With regard to the footer, z attributives are created: T1, T2, . . . , Tz;
A Table Main is created, whose fields are: H1, H2, H3, . . . , Hx and T1,T2, . . . ,Tz, where H1 stores the header number;
A Table Detail is created, whose fields are: H1 and B1, B2, . . . , By, where H1 stores the form number.

2. The method for creating relational database table (s) for a form defined in claim 1 wherein the z attributives in the footer are used for storing information of form handling person, auditors at all levels and status.
